(19) United States
(12) Patent Application Publication
(10) Pub. No.: US 2005/0206158 A1
(43) Pub. Date: Sep. 22, 2005

(54) Certificate issuing method and certificate verifying method

(75) Inventors: Hideo Noyama, Yokohama (JP); Takeshi Matsuki, Musahino (JP); Hirofumi Inomata, Tokyo (JP); Kenji Yokoi, Fujimi (JP); Shuji Terada, Kawasaki (JP); Mitsuru Iwamura, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Touchstone Research Laboratory, Ltd.

(21) Appl. No.: 11/053,859

(22) Filed: Feb. 10, 2005

(30) Foreign Application Priority Data
Feb. 13, 2004 (JP) 2004-035902

(51) Int. Cl. G09C 3/00

(52) U.S. Cl. 283/74

(57) ABSTRACT

The board issuing/managing system is provided with a processing unit to manage a board ID number and a processing unit to write a coded ID number into board data. Further, the certificate issuing system is provided with a processing unit to give an electronic signature of a certificate issuer to associated data to be written over the board data; a processing unit to transform encrypted associated data into code information that can be read by an information processing device; a processing unit to insert the board ID number as an electronic watermark when the associated data includes image data; and a processing unit to arrange the code information, the image data and the associated data on the board so that they do not overlap each other.

### INCORPORATION BY REFERENCE

This application claims the priority benefit of Japanese Patent Application No. 2004-035902, filed on Feb. 13, 2004, the entire description of which is incorporated herein by reference.

### BACKGROUND OF THE INVENTION

The present invention relates to a technology for creating a certificate and verifying it. More specifically, this invention relates to a certificate issuing method that allows certificate data issued online to be printed by a user's printer and to a certificate verifying method that enables a verifier to authenticate the printed matter without having to referring to the certificate issuer.

This invention concerns a technology for brokering transactions of products including software via network and more particularly a technology for identifying a person (organization) that supplies a product in a business transaction or the product itself.

Among conventional technologies related to electronic certificates are: JP-A-2001-134672 which verifies the genuineness and validity of a printed matter offline; JP-A-2001-357154 that allows an applicant seeking a certificate to use a printed matter printed by the applicant as a public certificate; and JP-A-2002-279099 that searches for certificate data using key information and database made up of information identifying individuals and the associated certificate data.

### SUMMARY OF THE INVENTION

A first object of this invention is to provide a system and a method that can issue a certificate online from whatever printer that satisfies a predetermined function, without having to use special print mediums or special printing apparatus.

A second object of this invention is to provide a system and a method that enable a verifier to easily verify a validity of the certificate.

To achieve these objectives, the present invention provides a certificate issuing method, which comprises the steps of: inputting associated information of a certificate issuance requesting client; generating electronic data of a board having a part of a background pattern unique to each certificate; writing the associated information in the form of characters over the background pattern of the board electronic data; writing on the board a relation between the background pattern and the characters written over the background pattern; and printing the electronic data as a certificate.

The present invention also provides a certificate verification method which comprises the steps of: transforming a certificate into electronic data; reading a relation between a background pattern on the certificate and characters written over the background pattern; extracting from the certificate an area in which associated information is written in the form of characters over the background pattern; checking if the background pattern and the characters in the area satisfy the relation thus read out; and deciding that the certificate is not valid when the relation is not satisfied.

Other objects, features and advantages of this invention will become apparent from the following description of embodiments thereof taken in conjunction with the accompanying drawings.

### BRIEF DESCRIPTION OF THE DRAWINGS

FIG. 1 is an explanatory diagram showing an example certificate issued online by this invention.

FIG. 2 is a system diagram showing an example link or connection between systems in this invention.

FIG. 3 is an explanatory diagram showing information attached to the certificate of FIG. 1 that authenticates the printed certificate.

FIG. 4 is an explanatory diagram showing processing performed on an area 120 and an area 130 in FIG. 1.

FIG. 5 is an explanatory diagram showing a method of painting out areas in FIG. 4.

FIG. 6 illustrates a basic flow of processing to issue a certificate online.

FIG. 7 illustrates a basic flow of processing to authenticate a printed certificate.

FIG. 8 is an explanatory diagram showing an example dot pattern different from FIG. 4.

FIG. 9 illustrates a system configuration of a board issuing system.

FIG. 10 illustrates a system configuration of a certificate issuing system.

FIG. 11 illustrates a system configuration of a verifier system.

FIG. 12 illustrates a system configuration of a client system.

FIG. 13 is a flowchart showing a process of generating a pattern of painted-out areas where individual data is to be written according to a second embodiment of this invention.

FIG. 14 is a detailed flowchart of Step 1350 in FIG. 13.

FIG. 15 is an explanatory diagram showing an example pattern generated by the processing of FIG. 13.

FIG. 16 illustrates a flow of processing to write associated data on the board pattern of the second embodiment.

FIG. 17 is an explanatory diagram showing an example applying a board pattern painting Voronoi diagram according to a third embodiment of the invention.

FIG. 18 illustrates a correspondence table representing a correspondence between 2×2-pixel painted-out patterns and the corresponding colors.

FIG. 19 illustrates an example applying the paint-out correspondence table of FIG. 18 to the surrounding of a written character.

FIG. 20 illustrates a result of performing paint-out processing on FIG. 19.

FIG. 21 is a diagram showing colors extracted at dot positions by superimposing FIG. 20 and FIG. 17 to determine colors for painting out individual areas in the Voronoi diagram.

FIG. 22 is an explanatory diagram showing an example of painting out characters written in an area where individual data of certificate is placed and the surrounding of characters.

FIG. 23 is an explanatory diagram showing a Japanese hirakana “ [symbol] ” partly modified which is then applied the correspondence table of FIG. 18.

FIG. 24 is an explanatory diagram showing an example in which the surrounding of the modified character is painted out.

FIG. 25 is an explanatory diagram showing another method of representing a localized geometry using colors.

FIG. 26 is an explanatory diagram showing an example in which characters are written over the pattern of FIG. 15 and code information is embedded in the pattern.

### DETAILED DESCRIPTION OF THE EMBODIMENTS

Now, embodiments of this invention will be described in detail. Let us explain a first embodiment.

(1) System Configuration

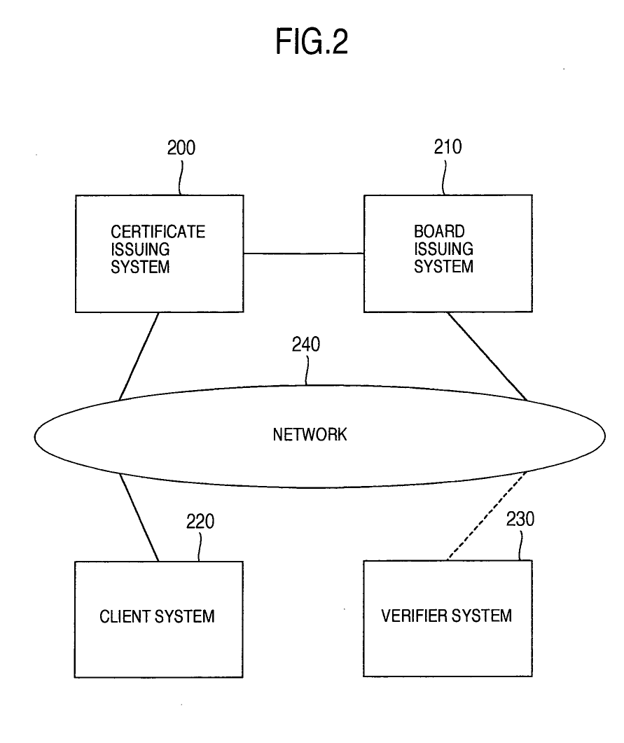

FIG. 2 shows a system configuration showing the connection or link between a certificate issuing system and a verification system. The entire system includes a certificate issuing system 200, a board issuing system 210 for preparing a board of the certificate, a client system 220 for requesting an issuance of the certificate, and a verifier system 230 for validating the certificate. The systems in FIG. 2 are computers that read programs from a storage medium onto memory and execute processing by a processor according to the program.

The certificate issuing system 200, the board issuing system 210 and the client system 220 are interconnected through a network 240. The verifier system 230 does not need to be connected with the network 240 at all times but is preferred to be connected according to the level of verification.

These systems are logical devices, and the certificate issuing system 200 and the board issuing system 210 may be implemented by the same computer. Further, the certificate issuing system 200 may include the client system 220.

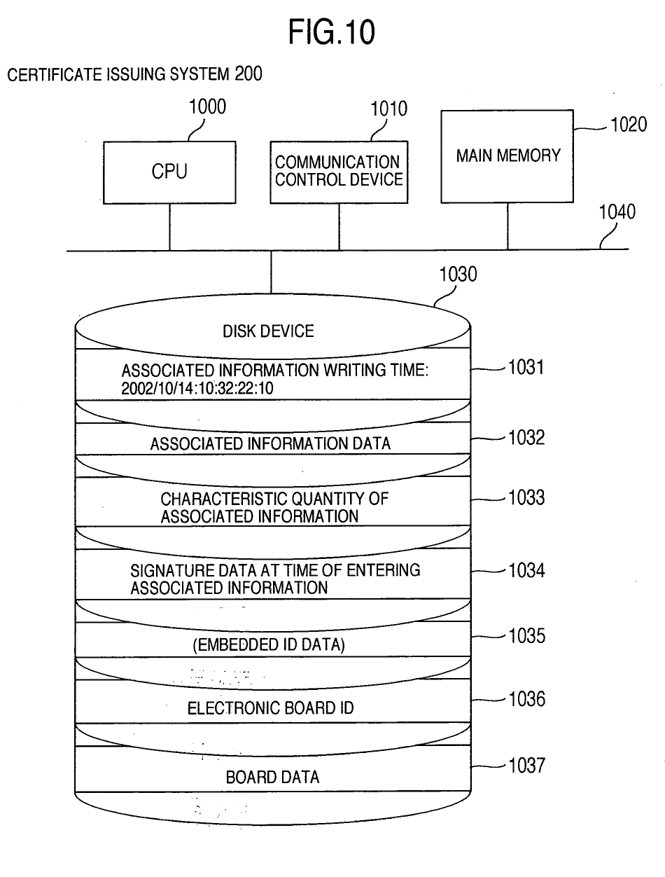

FIG. 10 shows the configuration of the certificate issuing system 200. The certificate issuing system 200 includes a CPU 1000, a communication control device 1010, a main memory 1020, a disk device 1030 and a bus 1040. The disk device 1030 stores data 1031-1037 used for issuing individual certificates in the form of table and also stores a certificate issuing program. The certificate issuing program is loaded into the main memory 1020 and executed by the CPU 1000.

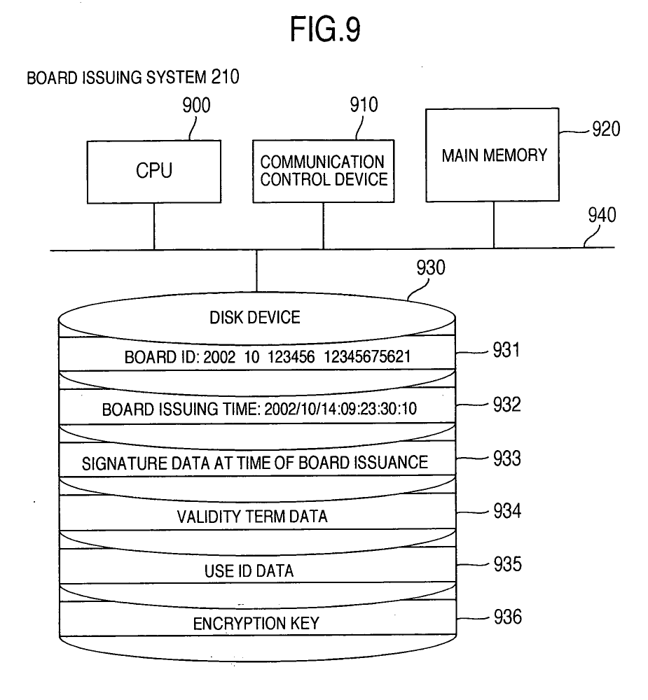

FIG. 9 shows the configuration of the board issuing system 210. The board issuing system 210 includes a CPU 900, a communication control device 910, a main memory 920, a disk device 930 and a bus 940. The disk device 930 stores data 931-936 used for issuing individual boards in the form of table and also stores a board issuing program. The board issuing program is loaded into the main memory 920 and executed by the CPU 900.

FIG. 12 shows the configuration of the client system 220. The client system 220 includes a CPU 1200, a communication control device 1210, a main memory 1220, an input device 1240 such as keyboard and scanner, a display 1250, an output device 1260 such as printer, and a bus 1230.

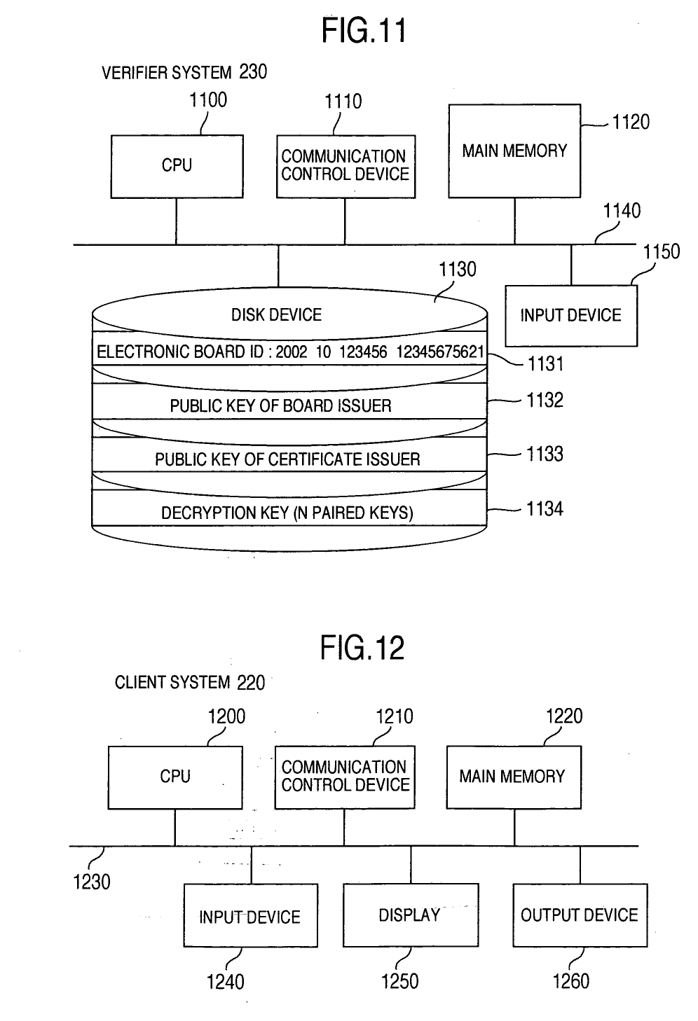

FIG. 11 shows the configuration of the verifier system 230. The verifier system 230 includes a CPU 1100, a communication control device 1110, a main memory 1120, a disk device 1130, a bus 1140, and an input device 1150 such as scanner. The disk device 1130 may store data 1131-1134 used for certificate authentication in the form of table and also stores a verification program. The verification program is loaded into the main memory 1120 and executed by the CPU 1100.

(2) Certificate

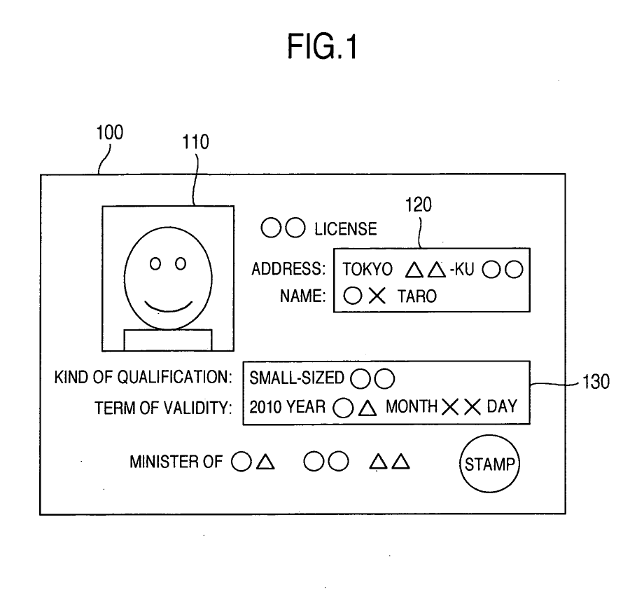

FIG. 1 shows an example certificate issued online. The certificate 100 in the example of FIG. 1 is a driver's license. Normally, the certificate 100 has an area 110 in which an identification photograph is posted, an area 120 in which data related to the individual, such as address, is shown, an area 130 in which a kind of the certificate and a term of validity are shown, and another area in which a signature or seal of a representative of the competent authorities is shown. Other examples include a business license, an identity card and a passport. Data shown vary depending on the certificate.

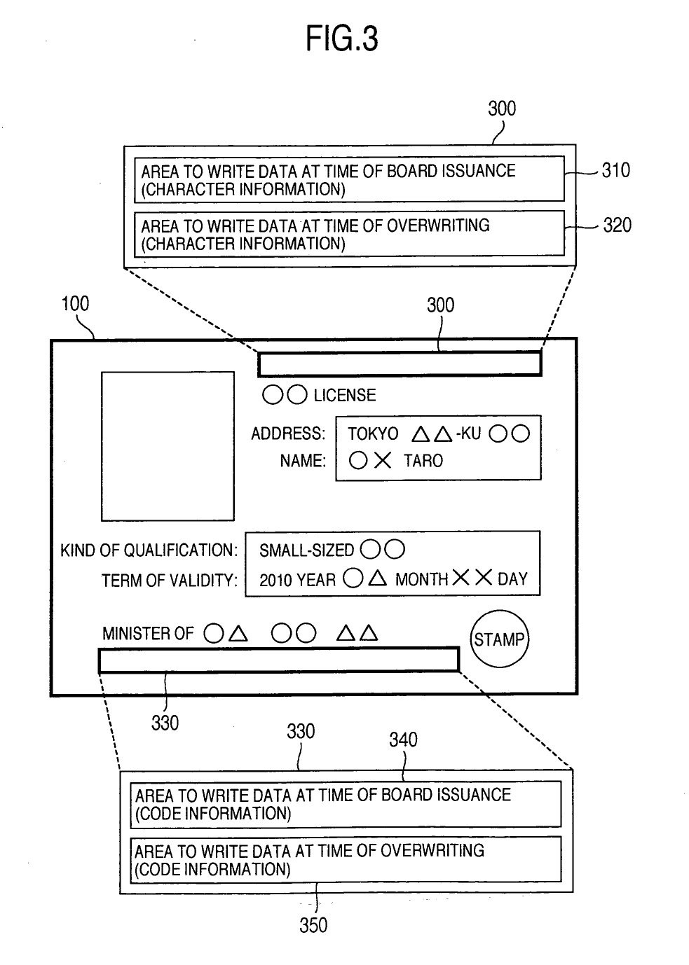

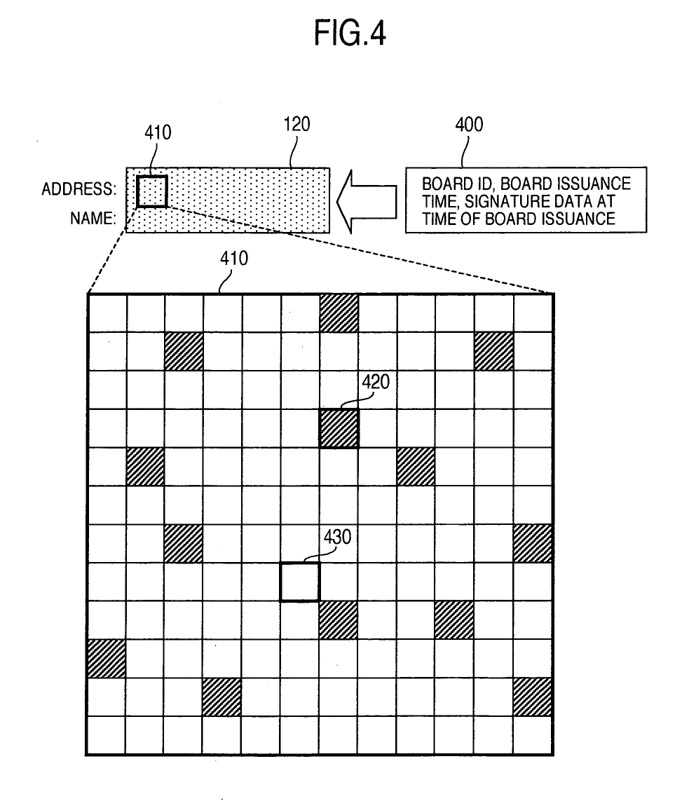

FIG. 3 and FIG. 4 show data to be added to FIG. 1 for the purpose of preventing a possible forgery. In FIG. 3, an area 300 for character information and an area 330 for code information are provided in an area other than the data area of FIG. 1. Here the character information refers to information represented by characters such as alphanumerics, Japanese kana and kanji, and thus can be read directly by a human, whereas the code information denotes information that can only be read by an information reader, such as bar code and two-dimensional code.

There are two types of bar code, a stack type that has bar codes superimposed together and a matrix type that has cells of the same size in black and white arranged two-dimensionally. The bar code may be other than these or a code that records information in the similar manner. It is also possible to record information unnoticeably over the entire surface of the certificate like electronic watermarking.

The area 300 for character information and the area 330 for code information are each divided into two fields. One field 310 (or 340) is given data, such as a board ID for managing the board, a board issuing time and a signature signed at the board issuing time, in the form of characters (or codes) by the board issuing system 210. Another field 320 (or 350) is written with data, such as a signature signed at the time of writing associated information and authenticating data, in the form of characters (or codes) by the certificate issuing system 200.

FIG. 4 shows processing performed on the area 120 and area 130 of FIG. 1 by the board issuing system 210. An image in the area 120 shown in FIG. 4 is generated by the board issuing system 210 transforming the data 400, such as board ID, board issuing time and signature data at time of board issuing, into a code and writing the code in the area 120. Over this image as a background the character information is written.

When a part 410 of the area 120 is enlarged, there are pixels 420 displayed as a black dot and pixels 430 appearing as a blank. For example, if characters are each 8-bit long and the data is expressed in hexadecimal notation, each character requires two digits. One digit of hexadecimal number is expressed by a 4×4-dot square with a value from 0 to 15 represented by the position of one black dot in the square. Therefore, one character can be represented by two squares (32 dots). Since the data 400 is made up of a string of characters, coding the data by the method described above results in the area 120 being painted out in a pattern shown at 410. Here, we have described an example case where the data 400 is transformed into a simple code. The data 400 may be encrypted before being coded to prevent a possible forgery. It is also possible to repetitively write the data to fill the entire area with the pattern. Although the size of characters written into is 120×120 dots per character in this example, other size may be used.

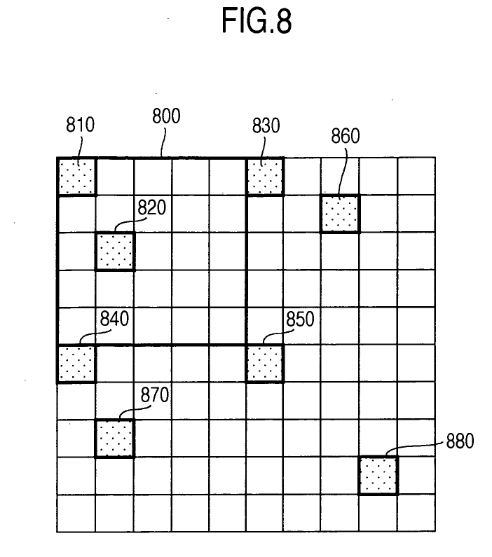

FIG. 8 shows another example of background pattern in the areas 120, 130. In FIG. 8, the paint-out area is divided into 5×5-dot squares 800, with an upper left corner pixel of each square 800 (810, 830, 840, 850) painted out as a dividing reference point of hexadecimal code. Then, the lower right 16 dots in each square 800 is matched to the previously mentioned 4×4-dot square. Although this arrangement makes the character string information randomly distributed as indicated by pixels 820, 860, 870, 880, since the reference point pixels 810, 830, 840, 850 are arrayed in regular order, data can be detected easily.

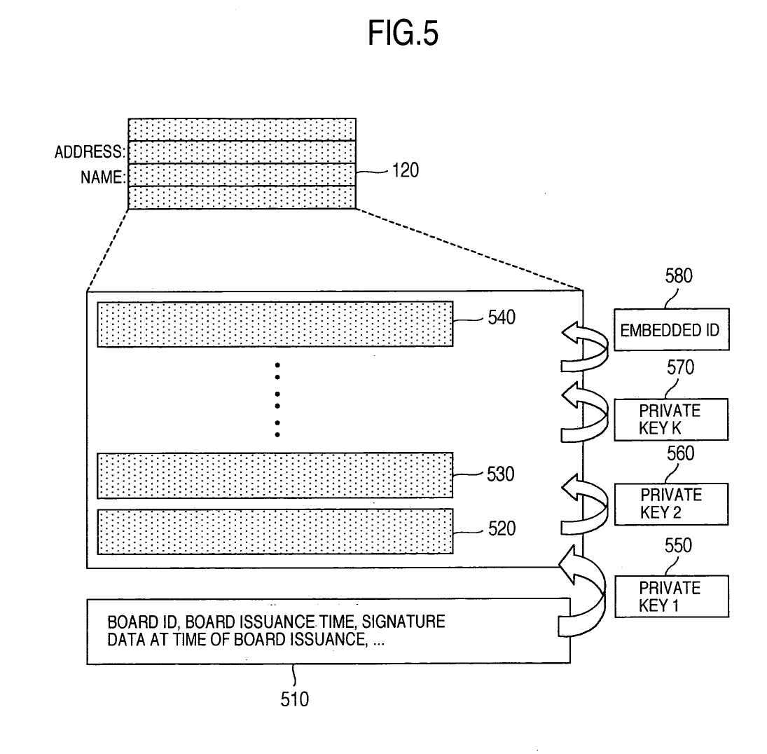

FIG. 5 shows an example method of painting out areas with coded patterns. When the content of data 510 is coded and the repetition area 120 is painted out, it is common practice to use the same pattern many times repetitively. For example, once a pattern 520 and a pattern 530 are known to be identical, if a part of the pattern 520 is erased by an overwriting character, the overwriting character can be eliminated by using the pattern 530. To prevent this, the board issuing system 210 prepares several private keys, creates encrypted data 1 using a private key 1 (550), transforms the encrypted data 1 into a coded pattern and writes the coded pattern in the area 520. Then, the board issuing system 210 generates encrypted data 2 by encrypting the encrypted data 1 using a private key 2 (560), transforms the encrypted data 2 into a coded pattern and writes the coded pattern in the area 530. This process is repeated to paint out the area 120. Since the pattern used in the area 520 and the pattern used in the area 530 differ, the above-described tampering can be prevented.

FIG. 5 shows an operation using an embedded ID 580 in place of a private key k+1. This embedded ID is a kind of random number.

It is possible to use a single private key or alternately use two private keys. The embedded ID may not be used.

(3) Issuance of Certificate

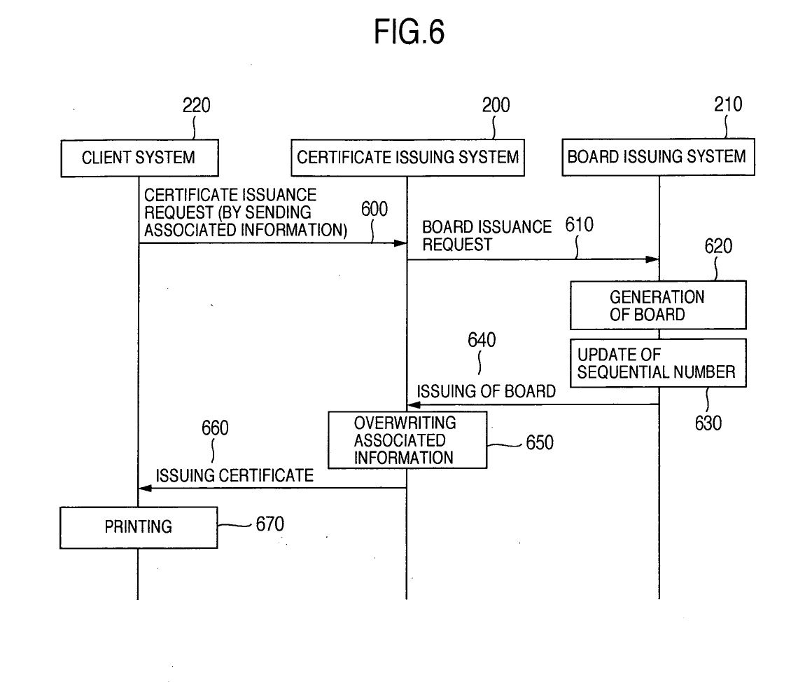

FIG. 6 shows a basic flow of the process of issuing a certificate online.

The client system 220 accepts personal information, such as address, name and photograph, from a person seeking a certificate. The client system 220 may have a device for authenticating an individual. The client system 220 sends to the certificate issuing system 200 the accepted personal information and the associated information, such as the kind of certificate and the term of validity, in the form of electronic data.

The certificate issuing system 200 in Step 600 of FIG. 6 accepts the certificate issuance request from the client system 220. Then, the certificate issuing system 200 in Step 610 identifies the kind of certificate and requests the board issuing system 210 to issue a board.

In response to the request of Step 610, the board issuing system 210 creates a unique board ID each time it issues a board. The board ID is for example a concatenation of a code representing the kind of certificate and a sequential number in that kind of certificate. Further, the board ID may include a random number.

The board issuing system 210 in Step 620 generates a board, that is, electronically generates the board data shown in FIG. 1. Further, it writes in the area 310 and area 340 of FIG. 3 a board ID, a board issuing time and signature data at time of board issuance by using characters and codes. The signature data at time of board issuance typically refers to data generated by encrypting a hash value of concatenated data of the board ID and board issuance time using a private key of the board issuing system 210. The area 120 and area 130 are also written with the background patterns in the method described above.

The board issuing system 210 stores information at time of board issuance in the disk device 930 of FIG. 9 for each board ID. The disk device 930 stores a board ID 931, a board issuance time 932, and signature data 933 at time of board issuance. Attribute information of the board is also stored in the form of validity term data 934 and use ID data 935. Further, the encryption keys used for generating background data explained with reference to FIG. 4 and FIG. 5 may be stored in an area 936.

Next, the board issuing system 210 in Step 630 (FIG. 6) updates the sequential number.

The board issuing system 210 in Step 640 transmits the issued board data (electronic data) to the certificate issuing system 200 by using the communication control device 910.

The certificate issuing system 200 in Step 650 receives the board data via the communication control device 1010 and enters the associated information into the board data. That is, it attaches an image to the area 110 and writes the associated information (address, name, term of validity, etc.) in the area 120 and area 130 in the form of characters. In the image area 110, information such as board ID is inserted by using an electronic watermarking technology. Further, the total number of black dots (before characters are written) in the area 120 and area 130, the total number of black dots painted out by the characters written over the areas, and their coordinates are recorded as data to be used for verification.

Further, the signature data of the associated information and the authenticating data are written into the area 320 and area 350 of FIG. 3 in the form of characters and codes, respectively. The signature data of the associated information typically refers to data generated by encrypting a hash value of the associated information using a private key of the certificate issuing system 200. The data used for authentication is preferably written only in the form of codes.

The certificate issuing system 200 stores information at time of certificate issuance in the disk device 1030 shown in FIG. 10 for each certificate. The disk device 1030 stores a certificate issuance time 1031, associated information 1032, a hash value 1033 of the associated information, and signature data 1034 of the associated information. The disk device 1030 also has an area for managing information on the board, in which a board ID 1036 and board data 1037 sent over from the certificate issuing system 200 are stored. The certificate issuing system 200 may also receive from the board issuing system 210 an embedded ID used when generating the background pattern of FIG. 5 and store it in an area 1035.

The client system 220 in Step 660 (FIG. 6) can retrieve certificate data (electronic data) using the communication control device 1210 and display it on the display 1250. In Step 670, the client system 220 sends the certificate data to the output device 1260 for printing.

The board issuing system 210 in Step 620 generates a board for the image of FIG. 4 or FIG. 5. When the board is issued, the area 310 and area 340 are recorded with information such as board ID. That is, if the dot patterns for the area 120 and area 130 are generated according to the information recorded in the areas 310 and area 340, it is possible to detect overlapping regions between the dot patterns and the characters written over the dot patterns without actually printing the dot patterns. Therefore, the board generation processing in Step 620 does not need to include the step of actually printing the dot patterns in the areas 120 and area 130 over which the associated information is to be written.

(4) Authenticating Certificate

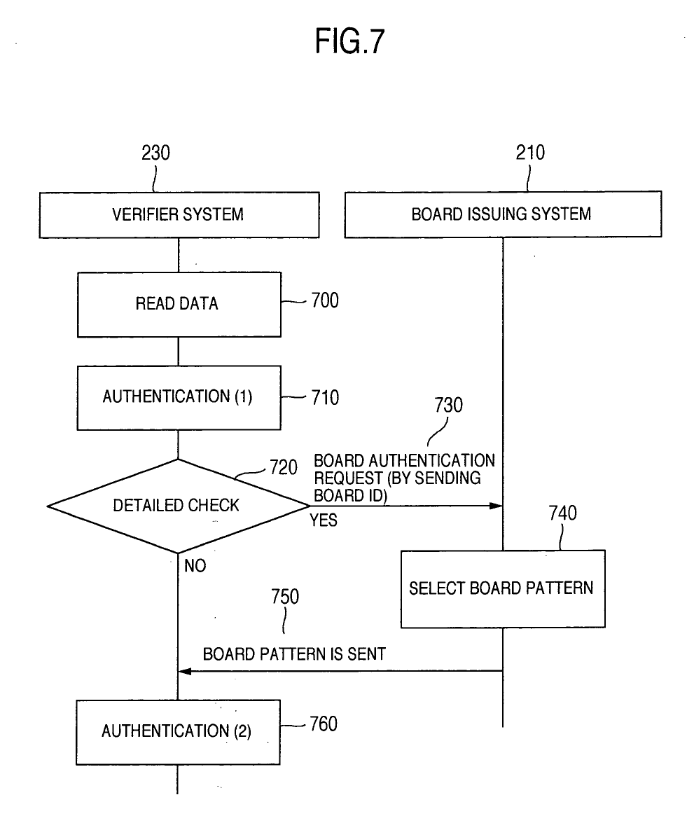

FIG. 7 shows a process to authenticate a certificate. The verifier system 230 in Step 700 reads a certificate as a printed matter by using a scanner 1150. In Step 710 the verifier system 230 performs a local authentication operation (authentication (1)) within its own system.

A common method of forging a certificate involves (a) erasing original letters (associated information) and writing other letters in their place or (b) modifying the existing letters to transform them into other letters. The certificate has recorded in the area 350 in the form of code the authenticating data which includes the total number of black dots (before characters are written) in the area 120 and area 130, the total number of black dots painted out by the characters written over the areas, and their coordinates.

In Step 700 the verifier system 230 counts the number of black dots in the background pattern in the area 120 and area 130 of the certificate read in, and compares it with the authenticating data on the area 350. If the comparison finds that they do not agree, the verifier system 230 decides that the certificate is not valid. This processing can detect the above-described tampering with a significantly high probability. Further, the verifier system 230 can increase the probability of detecting a forgery by comparing the coordinates of black dots painted out by the characters in the authenticating data and the positions of characters in the area 120 and area 130 of the certificate read in.

Further, if an even higher level of authentication is required (720), the verifier system 230 connects to the network 240 to perform one of the following authentication operations (authentication (2)) or some or all of them.

Case 1: The verifier system 230 extracts the board ID from the area 310 of the certificate read in, sends the board ID to the board issuing system 210 and requests it to perform the board authentication (Step 730). The board issuing system 210 recovers a background pattern from the stored data and returns it to the verifier system 230 (Step 730). The verifier system 230 checks if the background pattern of the certificate read in and the background pattern sent over from the board issuing system 210 agree in areas other than the characters (Step 760). This process can detect when the background pattern is forged.

Case 2: The verifier system 230 extracts signature data from the area 300 or 330 of the certificate read in, retrieves a public key for the board issuing system 210 and the certificate issuing system 200, and verifies the signature data. This is a well known electronic signature authentication method. The public key may be stored in the disk device 1130 of the verifier system 230. This verification process may be performed together with the authentication (1).

Case 3: The background patterns in the areas 120, 130 are generated by repetitively using the same one set of data of FIG. 5. This process can only be applied where no characters are written over a predetermined area of pattern for one set of data. The verifier system 230 extracts the pattern in a predetermined area for one set of data from the areas 120 and 130 of the certificate read in. Using the embedded ID used in FIG. 5, the public key corresponding to the private key used in FIG. 5 and the extracted pattern, the process of FIG. 5 is reversed to recover the background pattern of the areas 120 and 130. By comparing the background pattern read in with the recovered background pattern, it is possible to detect a forgery of the background pattern. A recovery key used in this process may be stored in the disk device 1130 of the verifier system 230.

Next, the second embodiment of this invention will be described.

(1) Issuance of Certificate

In this embodiment, the board issuing system and the certificate issuing system are implemented as one and the same system (board/certificate issuing system). The method of generating background patterns in the area 120 and area 130 of the certificate differs from that of the first embodiment. In addition to the use of a plurality of colors in the background pattern, this embodiment is characterized in that the background pattern changes according to the associated information. In other respects, the configuration is similar to that of the first embodiment.

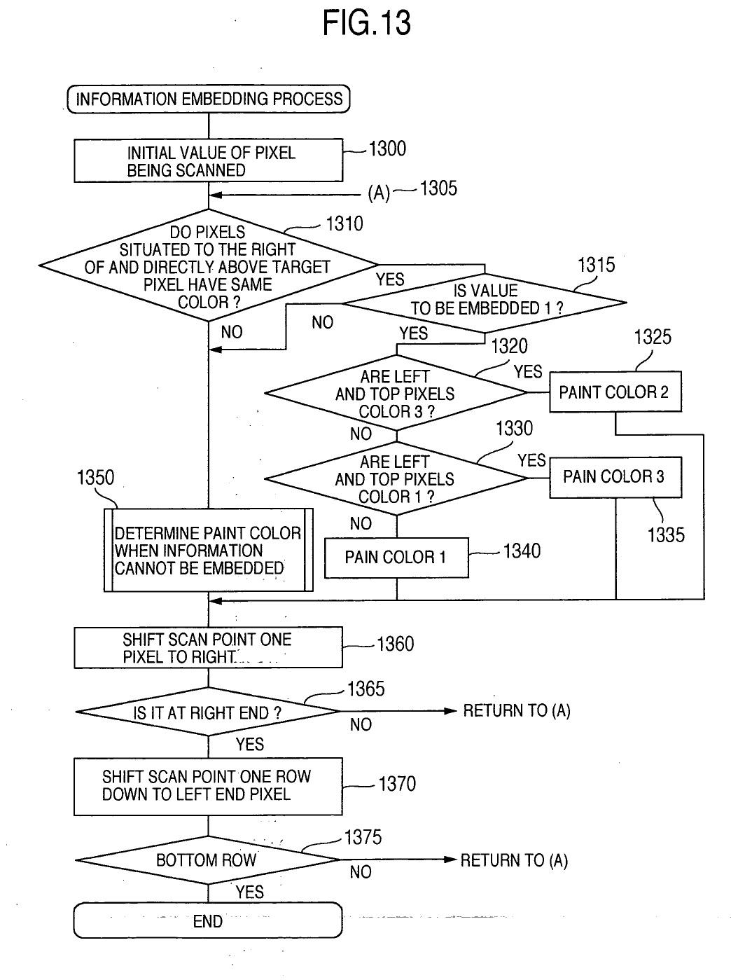

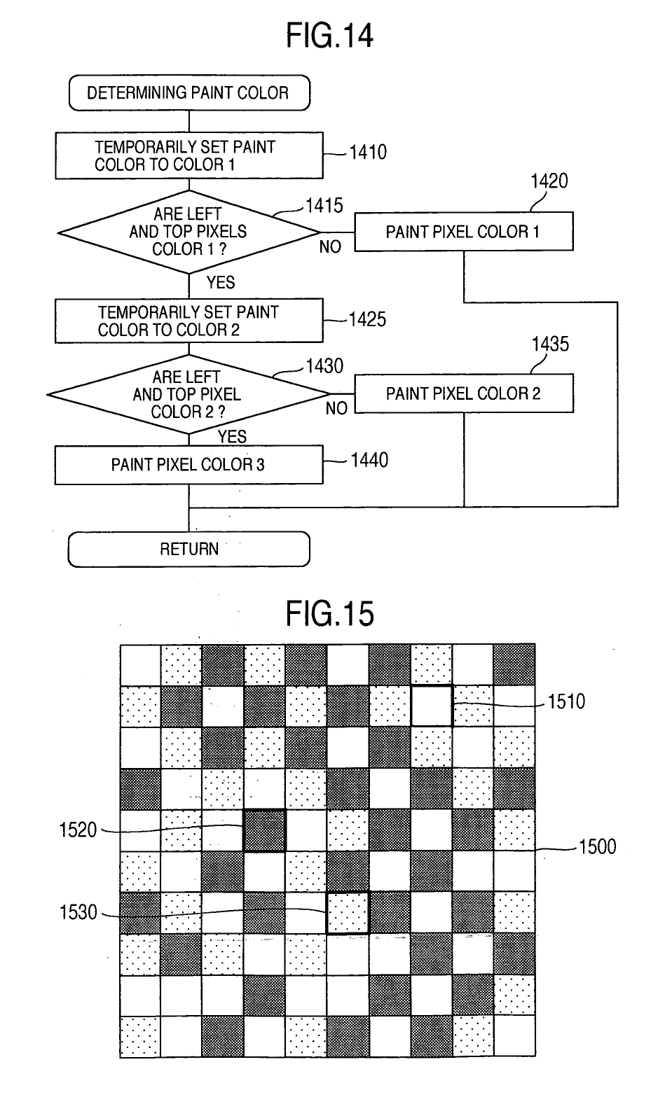

FIG. 13 and FIG. 14 are flowcharts for a method of generating a pattern that paints out the area 120 and area 130. First, a fundamental pattern generation method is briefly explained. A basic pattern is created by painting pixels in these areas in three different colors (Color 1, Color 2, Color 3) in such a manner that adjoining pixels in any directions, up, down, left or right, have different colors. The simplest method of painting is to repetitively paint Color 1, Color 2 and Color 3 in a predetermined order. That is, the top row of pixels is painted in three different colors repetitively in the order of Color 1, Color 2 and Color 3. On the next row down, the pixels are applied three different colors repetitively in the order of Color 2, Color 3 and Color 1 from left to right, with the leftmost pixel painted Color 2. On the third row, the pixels are painted Color 3, Color 1 and Color 2 in that order from left to right, with the leftmost pixel painted Color 3. This process is repeated down to the bottom row to paint out the area 120 and area 130. This is called a basic pattern. Primary colors commonly used in printers may be used. For instance, the three colors may be chosen from cyan, magenta, yellow and black. Four colors may be used instead of three.

Next, a board ID and the associated information are embedded in the basic pattern. This processing is shown in FIG. 13.

The board/certificate issuing system in Step 1300 sets an initial value to scan the area 120 or area 130. For example, the upper left pixel is set as the initial value. In Step 1310, a check is made as to the colors of pixels situated to the left of and directly above a target pixel. If these two pixels have the same color, the processing proceeds to Step 1315. If their colors do not agree, the processing moves to Step 1350.

In Step 1315, the board/certificate issuing system decides whether the information should be embedded in the pixels. Suppose, for example, the board ID is “11” and this ID is to be embedded in the image. The number “11” is a decimal value which, when expressed in binary notation, is “1011”. Thus, embedding the decimal value of “11” into the image requires at least four pixels, in which “1”, “0”, “1” and “1” are embedded respectively. Returning to Step 1315, it is checked whether the value to be embedded in the image of interest is “1” or “0”. If the value is found to be “1”, the processing moves to Step 1320. If the value is “0”, the processing moves to Step 1350. Step 1320 checks the colors of the pixels situated to the left of and directly above the pixel of interest. If their colors are Color 3, Step 1325 paints the pixel of interest Color 2.

If the colors of the pixels checked are found to be Color 1, rather than Color 3, Step 1330 makes a further check and Step 1335 paints the pixel of interest Color 3. If the colors of the pixels checked are neither Color 3 nor Color 1, their colors are necessarily Color 2. So, the pixel in question is painted Color 1 in Step 1340. Step 1350 is the processing that determines the color of a pixel in which the information cannot be embedded. This processing will be explained by referring to FIG. 14.

Once the color of the pixel under consideration is determined, Step 1360 shifts the scan point one pixel to the right. If the pixel currently being scanned is at the rightmost end of the row, the processing moves from Step 1365 to Step 1370. If not, the processing returns to Step 1305. Similarly, Step 1370 shifts the scan point one row down. If the current scan point is found to be on the bottom row in Step 1375, the processing is exited. If not, the processing returns to Step 1305 and continues its execution.

FIG. 14 is a detailed flow of Step 1350. The board/certificate issuing system in Step 1410 temporarily sets the painting color of the pixel of interest to Color 1. Step 1415 checks the colors of pixels situated to the left of and directly above the pixel of interest. If neither of them is Color 1 (i.e., possibilities are that both of them are Color 2, both of them are Color 3, or one of them is Color 2 and the other Color 3), the pixel of interest is painted Color 1. If in Step 1415 at least one of the two pixels is Color 1, Step 1425 temporarily sets the paint color to Color 2. Then, Step 1430 checks the colors in the similar manner and if the colors of the pixels situated to the left of and directly above the target pixel are not Color 2, Step 1435 paints the pixel of interest Color 2. If, in Step 1430, Color 2 is found to be included, this means that one of the pixels situated to the left of and directly above the target pixel is Color 1 and the other is Color 2. So, Step 1440 paints the target pixel Color 3. With this processing, it is possible to embed the associated information in the basic pattern while keeping the rule of painting adjoining pixels different colors.

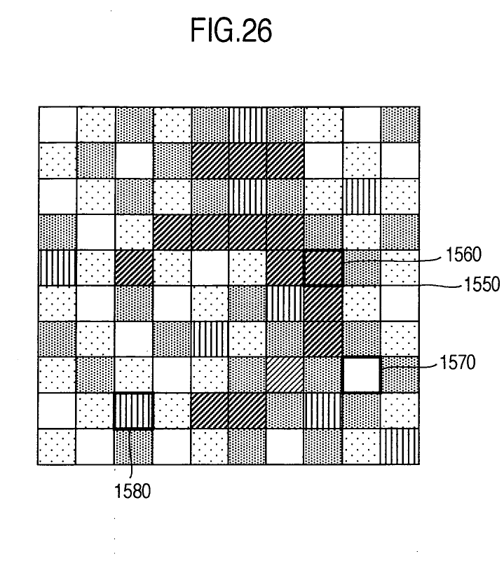

FIG. 15 shows an example pattern of board generated as described above. The associated information is written in the form of characters over the board pattern and its code or hash value is embedded in the background pattern. FIG. 26 shows an example in which a Japanese hiragana character is written on the board and in which a code or hash value of this hiragana character is embedded in the board.

In FIG. 15, a pixel 1510 in an area 1500 is painted Color 1, a pixel 1520 Color 2 and a pixel 1530 Color 3, so that all adjoining pixels are painted different colors. In FIG. 26, a pixel 1560 is superimposed with a hiragana character. Further, FIG. 15 shows an example in which a part 1580 painted Color 1 is embedded with code information representing the hiragana character.

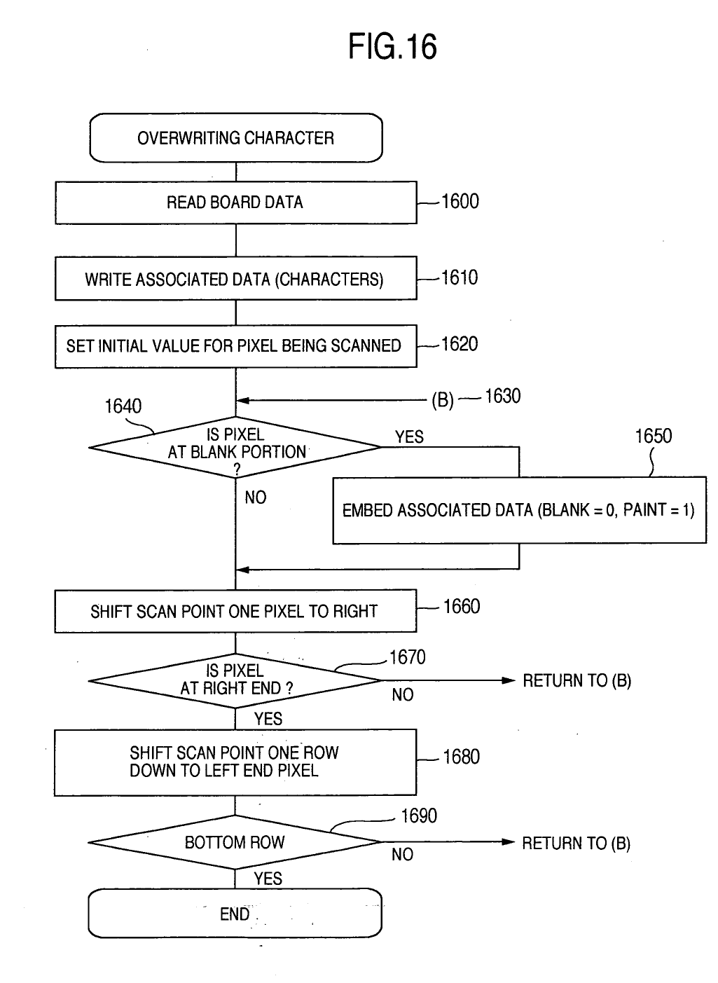

FIG. 16 shows a flow of processing to embed code information in the background pattern of the board. In Step 1600 the board data is read in, and characters of the associated data are written over the board (Step 1610). At this point of time, those pixels superimposed with the characters, such as pixel 1560, are painted a color of the characters (e.g., black).

In Step 1620, a pixel at the upper left corner of the area is set as an initial value. Step 1640 checks if the pixel under consideration has Color 1 (here, Color 1 is represented as blank). If the pixel has Color 1, the associated data is embedded in the same way as explained in FIG. 13. That is, Step 1650 leaves the paint color as is if the value to be embedded is “0” and, if the value to be embedded is “1”, sets the paint color to Color 4.

With the color of the target pixel determined, Step 1660 shifts the scan point one pixel to the right. If the current scan point is at the right end of the row, the processing moves from Step 1670 to Step 1680. If not, the processing returns to Step 1630. Step 1680 shifts the scan point one row down and, if Step 1690 finds that the current row is the bottom row, the processing is ended. Otherwise, the processing returns to Step 1630 and continues operation.

In this example, although one character is written over the board and the code information of that one character is embedded in the background pattern, it is possible to write all character information first and then repetitively embed their hash value in the background pattern.

In this example, authenticating data is not generated as it was in the first embodiment, nor is the authenticating data written in a certificate.

(2) Authenticating Certificate

The verifier system 230 performs the following verification operation. An electronic signature can be authenticated in this embodiment in the same way as in the previous embodiment. The verifier system 230 extracts a certificate read in and sends it to the board/certificate issuing system for authentication. The board/certificate issuing system compares the pattern and character information of areas 120, 130 stored for each board ID with those of the certificate transmitted, to see if they agree. It then returns a result of the check to the verifier system.

Next, a third embodiment will be described.

(1) Issuance of Certificate

In this embodiment, the board issuing system and the certificate issuing system are implemented as one and the same system (board/certificate issuing system). The method of generating background patterns in the area 120 and area 130 differs from that of the first embodiment. In addition to the use of a plurality of colors in the background pattern, this embodiment is characterized in that the background pattern changes according to the associated information.

In this embodiment, characters are first written over the areas 120, 130 of the certificate and then the background is painted by a plurality of colors.

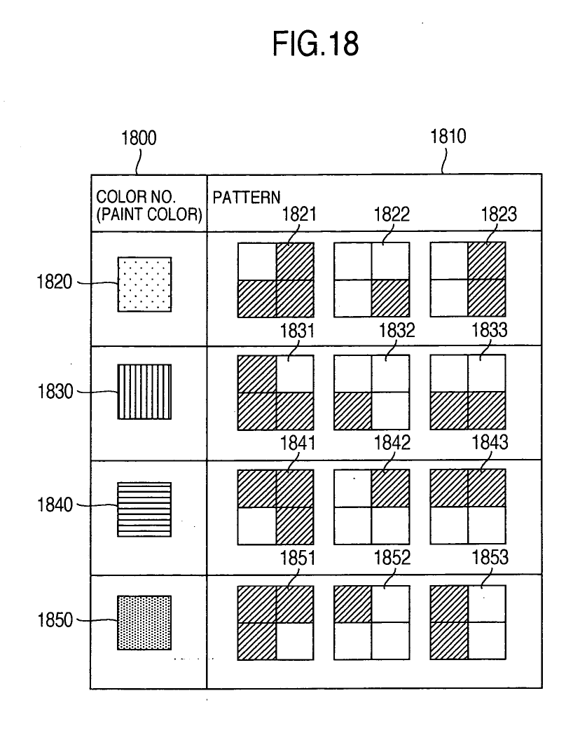

FIG. 18 shows a rule by which paint colors of surrounding areas of first written characters are determined according to local geometries of the characters. First, the areas 120, 130 in which the characters are written are divided into 2×2-pixel squares.

FIG. 18 is a table showing a relation between 2×2-pixel patterns 1810 including a character portion and paint color numbers 1800 for those pixels in the respective patterns which are not painted out. If a square made up of 2×2 pixels is taken as a unit, there are 14 patterns in which the pixels in the square are painted out by a character. Of these, 12 patterns, excluding one in which all four pixels are painted and one in which none of the four pixels is painted, are classified into four groups. For example, a color corresponding to pattern 1821, pattern 1822 and pattern 1823 is designated 1820; a color corresponding to pattern 1831, pattern 1832 and pattern 1833 is designated 1830; a color corresponding to pattern 1841, pattern 1842 and pattern 1843 is designated 1840; and a color corresponding to pattern 1851, pattern 1852 and pattern 1853 is designated 1850.

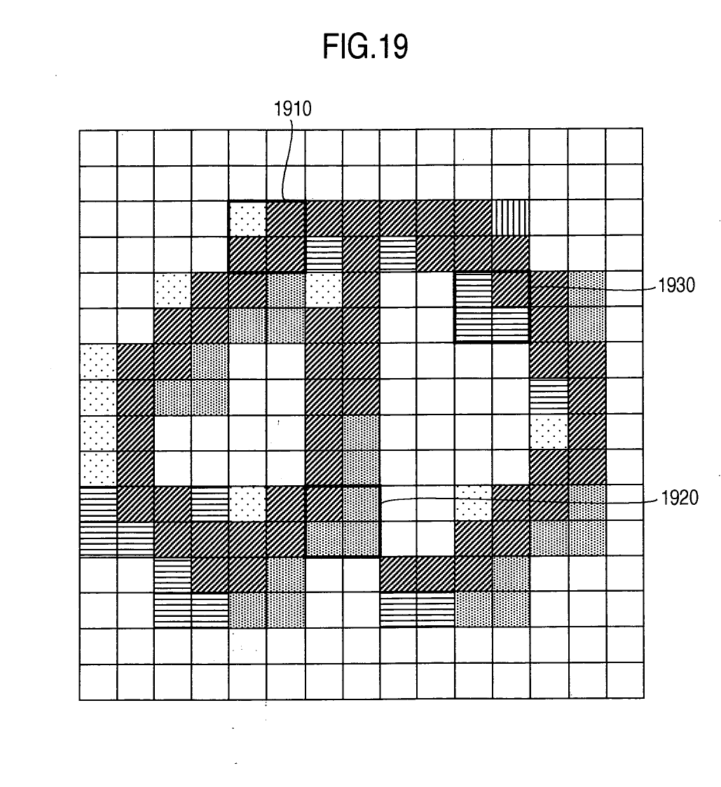

An example case in which this rule is applied to a Japanese hiragana character “ [symbol] ” is shown in FIG. 19. Since a square 1910 of FIG. 19 is identical to pattern 1821, a blank portion is painted Color 1820. Since a square 1920 is the same as pattern 1852, a blank portion is painted Color 1850. Further, a square 1930 is identical to pattern 1842, so a blank portion is painted Color 1840. Painting the surrounding of the hiragana character “ [symbol] ” in this way results in FIG. 19.

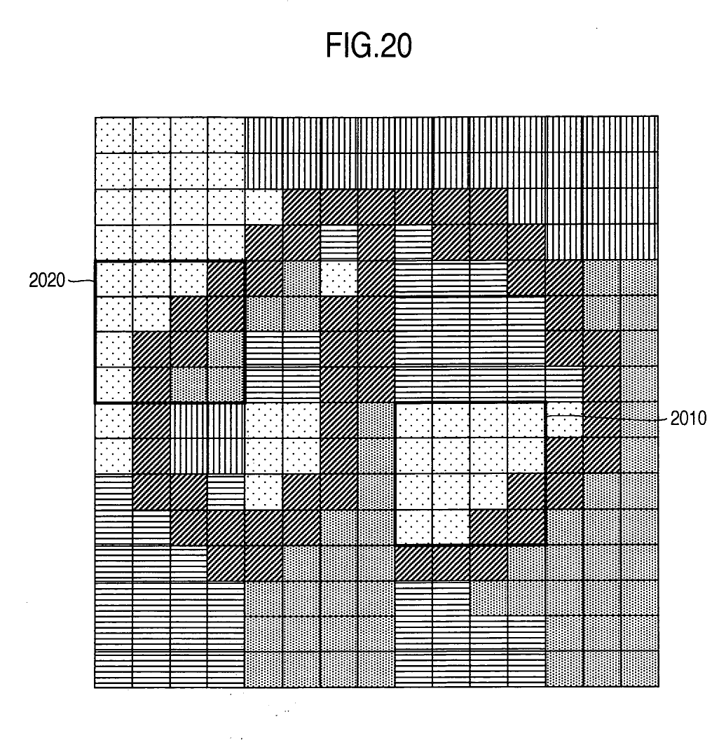

FIG. 20 shows how the colors of portions not painted out are determined by dividing an area into 4×4-pixel squares and applying the same rule as described above. For example, a square 2010 is identical to pattern 1822, so its blank portion is painted Color 1820; and a square 2020 is identical to pattern 1821, so its blank portion is painted Color 1820.

If the area under consideration is not painted out at all, the area is divided into 8×8-pixel squares to paint the blank portions; and if no painted portion is found, the area is again divided into 16×16-pixel squares to paint the blank portions. This process is repeated until a painted portion is found.

Next, the area that was painted out by the method described above is further embedded with information such as board ID. It is assumed here that the coded information of FIG. 4 of the first embodiment is embedded.

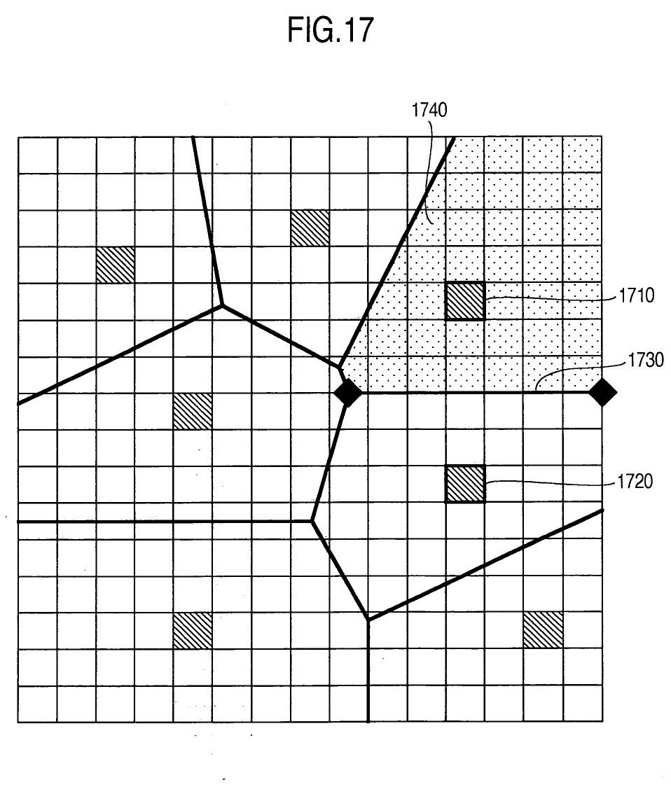

The dot pattern in FIG. 4 corresponds to pixel 1710 and pixel 1720 in FIG. 17. Using these pixels 1710, 1720, a Voronoi diagram is generated.

The Voronoi diagram is a well-known area dividing method, which is created as follows. Two adjoining points on the area are connected by a line. At a center point on the line, another line is drawn perpendicular to the first line. Repeating this operation for all points results in the area being divided as shown in FIG. 17. By generating the Voronoi diagram in this manner, a closed area including one dot can be defined for each of the dots contained in the pattern.

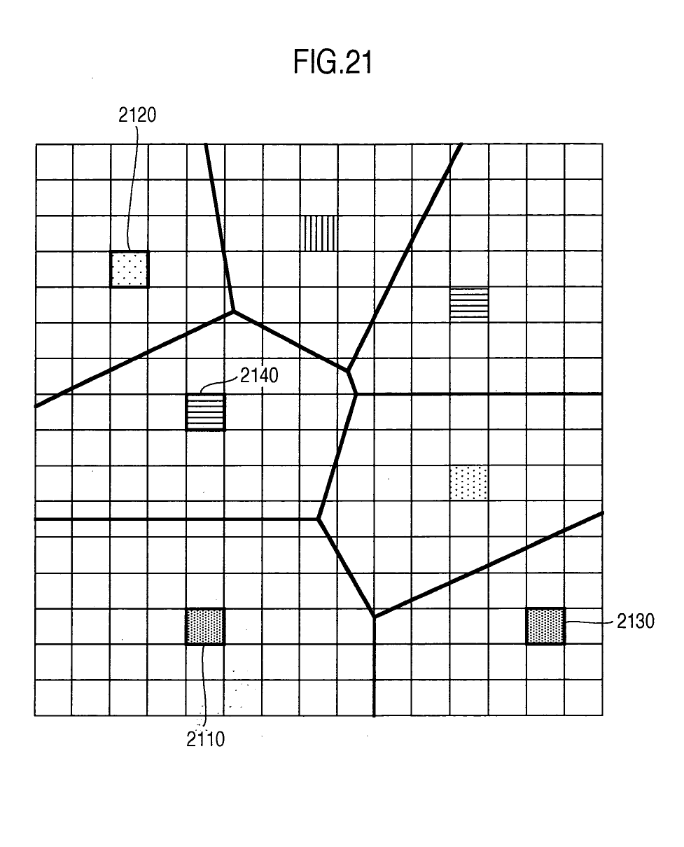

Superimposing FIG. 17 and FIG. 20 results in FIG. 21.

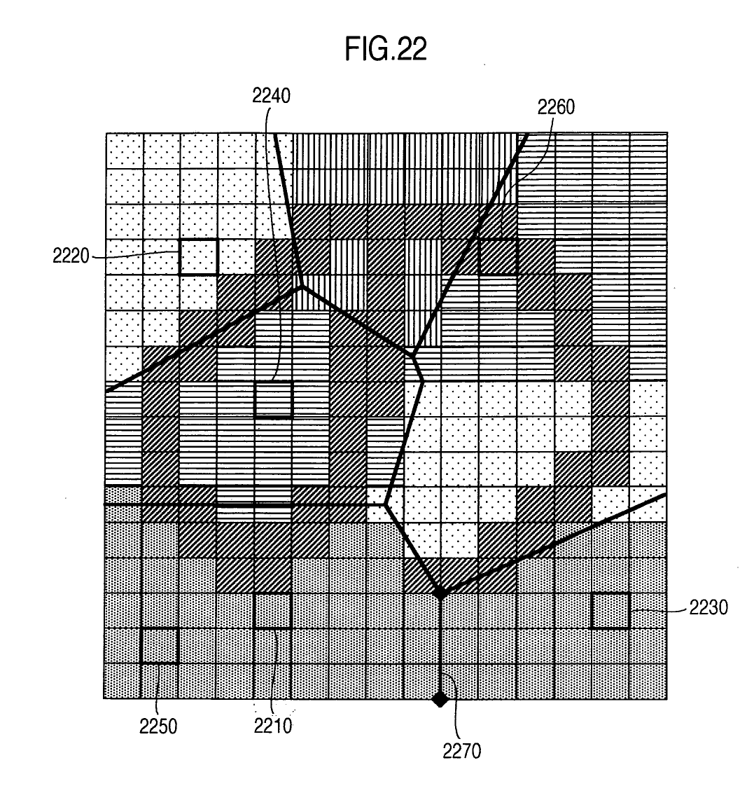

The interior of the closed area of FIG. 21 is painted in the dot color of the closed area. If the pixel of interest is written over by a character, as with pixel 2260, the interior of the closed area is painted in the color of the pixel closest to the target pixel. FIG. 22 shows an area other than the character painted out in this manner. The surrounding areas of the character are painted in four different colors.

The board/certificate issuing system generates the areas 120, 130 of the certificate in this way.

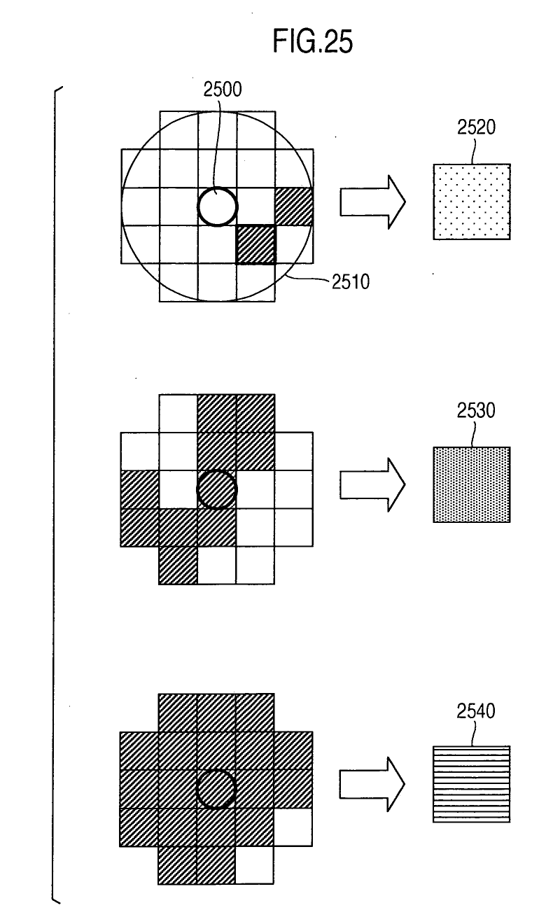

Another rule used instead of the paint-out rule of FIG. 18 is shown in FIG. 25. The rule in FIG. 25 determines the color according to how much of the surrounding area of the target pixel is written over by a character. In the surrounding area 2510 of the target pixel 2500, if the area written over by the character is less than 30%, Color 2520 is used; if the overwritten area is 30-60%, Color 2530 is used; and if the overwrittent area its mote than 60%, Color 2540 is used for painting the blank area. Then, the areas 120, 130 of the certificate are generated by the above method described with reference to FIGS. 21 and 22.

(2) Authenticating Certificate

The verifier system 230 performs the following verification operation. An electronic signature can be authenticated in this embodiment in the same way as in the previous embodiment. The verifier system 230 extracts characters in the areas 120, 130 of a certificate read in and paints the background using the method described with reference to FIGS. 18, 19 and 20 (or FIG. 25). Next, the verifier system 230 sends a board ID to the board/certificate issuing system to retrieve the dot pattern of FIG. 4 from the board/certificate issuing system. Using the dot pattern thus retrieved, the verifier system 230 repaints the background by the method explained with reference to FIGS. 21 and 22 and outputs it to a printer. By visually comparing a color pattern of the areas 120, 130 of the certificate with a color pattern output from the printer, it is possible to detect a tampering of the certificate. The verifier system 230 may compare the two color patterns and output a check result representing an agreement/disagreement between the patterns.

As a variation of this embodiment, information on coordinates of the dot pattern of FIG. 4 may be encoded at the time of certificate generation and recorded in the area 330 of the certificate. In this case, during the authentication of the certificate, the verifier system can perform the above-described authentication using the information on the certificate, without connecting to the board/certificate issuing system.

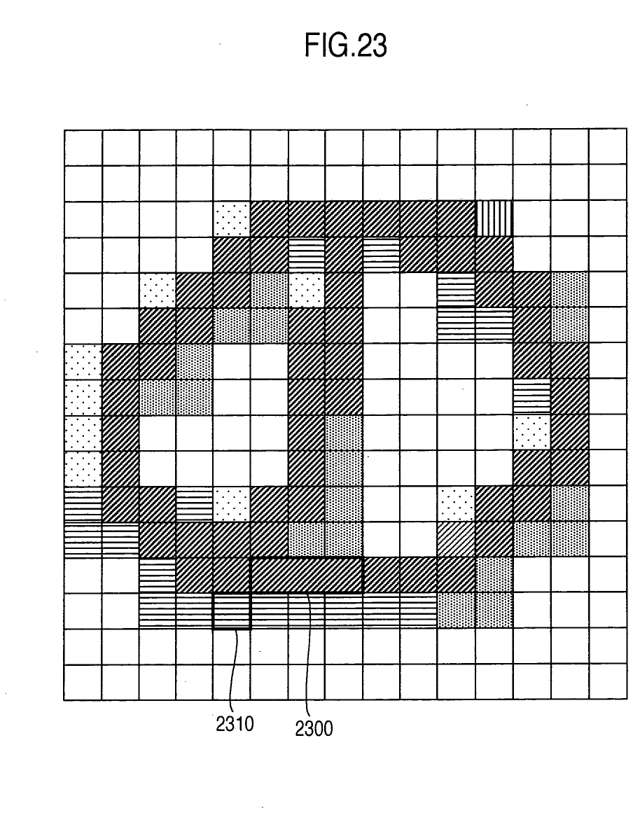

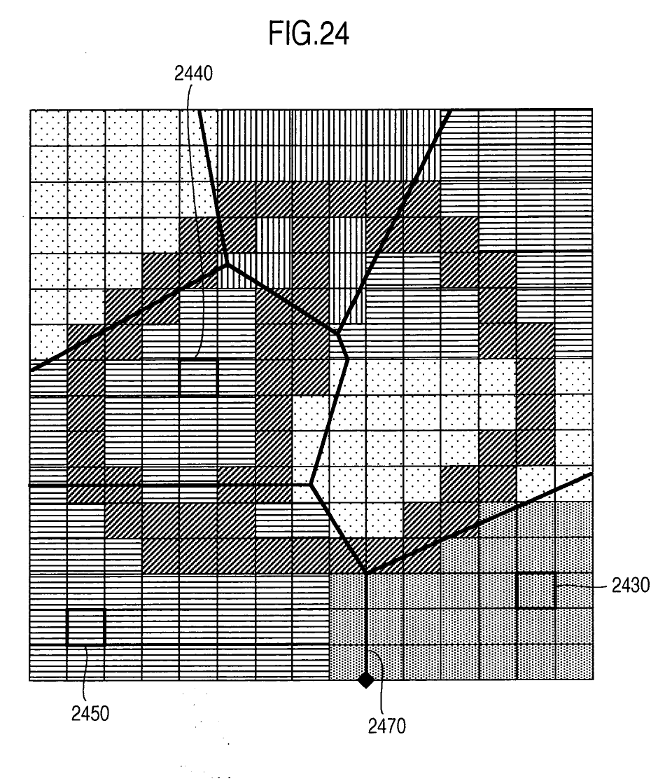

An example of alteration is shown. FIG. 23 shows a Japanese hiragana character “ [symbol] ” partly modified with an area 2300 painted out. In this character, if the rule of FIG. 18 is applied, dot 2310 is painted in Color 1840. FIG. 24 shows the area painted in colors according to the Voronoi diagram. In FIG. 22, dot 2230 and dot 2250 have the same color and the both sides of a boundary line 2270 are painted in the same Color 1850. Meanwhile, in FIG. 24 since dot 2430 and dot 2450 have different colors, the left side of the boundary line is painted in Color 1840 and the right side in Color 1850. Therefore, FIG. 22 and FIG. 24 are distinguishable even by visual check. Such a color change can result not only when a part of the character is tampered with but also when its position is shifted even slightly.

Although the above description concerns example embodiments, it should be appreciated by those skilled in the art that the present invention is not limited to these examples and that various modifications and changes can be made in the spirit of this invention and within the scope of the appended claims.

1. A method of issuing a certificate using a computer, comprising the steps of:
inputting associated information of a certificate issuance requesting client;
generating electronic data of a board having a part of a background pattern that is unique to each certificate;
writing the associated information in a form of a character over the background pattern of the board electronic data and writing a relation between the background pattern and the character written over it; and
printing the electronic data as the certificate.

2. The certificate issuing method according to claim 1, wherein the background pattern of the certificate board is a pattern generated by encoding information unique to each certificate and representing the coded information in the form of dots.

3. The certificate issuing method according to claim 2, wherein a relation between the background pattern and the character written over the background pattern includes a total number of dots in the background pattern before the character is written over the background pattern and a number of dots written over by the character.

4. The certificate issuing method according to claim 3, wherein a relation between the background pattern and the character written over the background pattern further includes information on coordinates of dots written over by the character.

5. The certificate issuing method according to claim 2, wherein a relation between the background pattern and the character written over the background pattern is encoded and written on the board.

6. The certificate issuing method according to claim 1, further including the steps of:
writing on the board information at time of board generation and an electronic signature assuring the information at time of board generation; and
writing on the board an electronic signature assuring the associated information.

7. A certificate comprising:
a background pattern unique to the certificate, partly printed on a board;
associated information written in a form of a character over the background pattern; and
a relation between the background pattern and the character written over the background pattern, the relation being written on the board.

8. A method of verifying the certificate issued by the method of claim 1, comprising the steps of:
transforming the certificate into electronic data;
extracting from the certificate an area on the background pattern in which the associated information is written over by a character;
reading a relation between the background pattern written on the certificate and the character written over the background pattern;
checking if the background pattern and the character in the area satisfies the relation read out; and
if the relation is not satisfied, deciding that the certificate is not valid.

9. A certificate issuing system comprising:
a client terminal to input associated information of a certificate issuance requesting client;
a board issuing device to generate electronic data of a board having a part of a background pattern, the background pattern differing from one certificate to another; and
a certificate issuing device to receive the electronic data of the board from the board issuing device, write the associated information received from the client terminal over the background pattern, and write on the board a relation between the background pattern and a character written over the background pattern;
wherein the client terminal prints the electronic data received from the certificate issuing device as a certificate.

10. A device to authenticate the certificate issued by the system of claim 9, comprising:
an input device to transform a certificate into electronic data;
a relation reading means to read a relation between a background pattern of the certificate and a character written over the background pattern;
an area extraction means to extract from the certificate an area in which associated information is written in the form of a character over the background pattern;
means to check if the background pattern and the character in the area satisfy the relation read out; and
decision means to decide that the certificate is not valid when the relation is not satisfied.

11. A method of issuing a certificate using a computer, comprising the steps of:
inputting associated information of a certificate issuance requesting client;
writing the associated information in a form of a character on electronic data of a board;
painting out a background portion of the associated information written in a form of a character according to a predetermined first rule by using a plurality of colors;
further repainting out the background portion of the associated information written in a form of a character according to a predetermined second rule by using information that is unique to each certificate;
storing a certificate ID number and the information unique to each certificate;
writing the certificate ID number on the electronic data of the board; and
printing the electronic data as a certificate.
